(19) United States
(12) Patent Application Publication
(10) Pub. No.: US 2018/0316978 A1
(43) Pub. Date: Nov. 1, 2018

(54) OUTPUTTING AN AUDIO SEGMENT AND/OR A VIDEO SEGMENT OF AN APPLICATION AT A FIRST DEVICE WHEN THE AUDIO SEGMENT AND/OR VIDEO SEGMENT IS NOT OUTPUT ON A SECOND DEVICE

(71) Applicant: QUALCOMM Incorporated, San Diego, CA (US)

(72) Inventors: Kiran KOONA, Miyapur (IN); Sravan Kumar Reddy ACHAMOLA, Hyderabad (IN); Prashanth MOHAN, Chennai (IN)

(21) Appl. No.: 15/498,442

(22) Filed: Apr. 26, 2017

(51) Int. Cl. H04N 21/63; H04N 21/414; H04W 76/02

(52) U.S. Cl. CPC H04N 21/632; H04W 84/12; H04W 76/023; H04N 21/41407

(57) ABSTRACT

In an aspect of the disclosure, a method, a computer-readable medium, and an apparatus are provided. The apparatus may pair with a second device via a wireless connection. The apparatus may also open an application on the first device. In one aspect, the application may include at least one of an audio segment or a video segment. In addition, the apparatus may route a signal associated with the at least one of the audio segment or the video segment to the second device via the wireless connection. Further, the apparatus may determine that the second device is unable to output the at least one of the audio segment or the video segment for a threshold time period. The apparatus may output the at least one of the audio segment or the video segment of the application on the first device when the threshold time period is reached.

### BACKGROUND

### Field

The present disclosure relates generally to communication systems, and more particularly, to outputting an audio segment of an application and/or a video segment of the application on a first device when the audio segment and/or video segment is not output on a second device.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to support mobile broadband access through improved spectral efficiency, lowered costs, and improved services using OFDMA on the downlink, SC-FDMA on the uplink, and multiple-input multiple-output (MIMO) antenna technology. However, as the demand for mobile broadband access continues to increase, there exists a need for further improvements in LTE technology. These improvements may also be applicable to other multi-access technologies and the telecommunication standards that employ these technologies.

A peripheral device may generally be defined as an auxiliary device that connects to and works with a computer in some way. Certain peripheral devices may connect to a computing device, such as a user equipment (UE), and provide an output of audio signals and/or video signals transmitted from the UE to the peripheral device. A non-exhaustive list of peripheral devices that may output an audio signal and/or video signal received from a UE may include a wireless headset, wireless speakers, wireless headphones, a smart television, a wireless tablet, etc.

In instances when one or more drivers that are used by the UE to route the audio signal and/or video signal to the peripheral device malfunction, neither the UE nor the peripheral device may output the audio signal and/or video signal, resulting in a compromised user experience.

There is a need to improve the user experience when one or more drivers used by the UE to route the audio signal and/or video signal to the peripheral device malfunction.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A peripheral device may generally be defined as an auxiliary device that connects to and works with a computer in some way. Certain peripheral devices may connect to a computing device, such as a UE, and provide an output of audio signals and/or video signals transmitted from the UE to the peripheral device. A non-exhaustive list of peripheral devices that may output an audio signal and/or video signal received from a UE may include a wireless headset, wireless speakers, wireless headphones, a smart television, a wireless tablet, etc.

In instances when the peripheral device is unable to output the audio signal and/or video signal, an interruption of the audio output and/or video output may occur.

There is a need to minimize an interruption of the audio output and/or video output when the peripheral device is unable to output the audio signal and/or video signal.

The present disclosure provides a solution by determining that the peripheral device is unable to output the audio signal and/or the video signal for a threshold time period, and outputting the at least one of the audio segment or the video segment of the application at the UE (e.g., a speaker and/or display screen at the UE) when the threshold time period is reached. By outputting the audio signal and/or the video signal at the UE when the peripheral device is unable to output the audio signal and/or video signal, an interruption of the audio output and/or video output may be minimized.

In an aspect of the disclosure, a method, a computer-readable medium, and an apparatus are provided. The apparatus may pair with a second device via a wireless connection. The apparatus may also open an application on the first device. In one aspect, the application may include at least one of an audio segment or a video segment. In addition, the apparatus may route a signal associated with the at least one of the audio segment or the video segment to the second device via the wireless connection. Further, the apparatus may determine that the second device is unable to output the at least one of the audio segment or the video segment for a threshold time period. The apparatus may output the at least one of the audio segment or the video segment of the application on the first device when the threshold time period is reached.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIGS. 1A and 1B are a flow diagram that may be used to output audio segment and/or video segment of an application at a first device when a second device is unable to output the audio segment and/or video segment in accordance with certain aspects of the disclosure.

FIGS. 2A-2C are a flowchart of a method of wireless communication.

FIG. 3 is a conceptual data flow diagram illustrating the data flow between different means/components in an exemplary apparatus.

FIG. 4 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

A peripheral device may generally be defined as an auxiliary device that connects to and works with a computer in some way. Certain peripheral devices may connect to a computing device, such as a UE, and provide an output of audio signals and/or video signals transmitted from the UE to the peripheral device. A non-exhaustive list of peripheral devices that may output an audio signal and/or video signal received from a UE may include a wireless headset, wireless speakers, wireless headphones, a smart television, a wireless tablet, etc.

In instances when the peripheral device is unable to output the audio signal and/or video signal, an interruption of the audio output and/or video output may occur.

There is a need to minimize an interruption of the audio output and/or video output when the peripheral device is unable to output the audio signal and/or video signal.

The present disclosure provides a solution by determining that the peripheral device is unable to output the audio signal and/or the video signal for a threshold time period, and outputting the at least one of the audio segment or the video segment of the application at the UE (e.g., a speaker and/or display screen of the UE) when the threshold time period is reached. By outputting the audio signal and/or the video signal at the UE when the peripheral device is unable to output the audio signal and/or video signal, an interruption of the audio output and/or video output may be minimized.

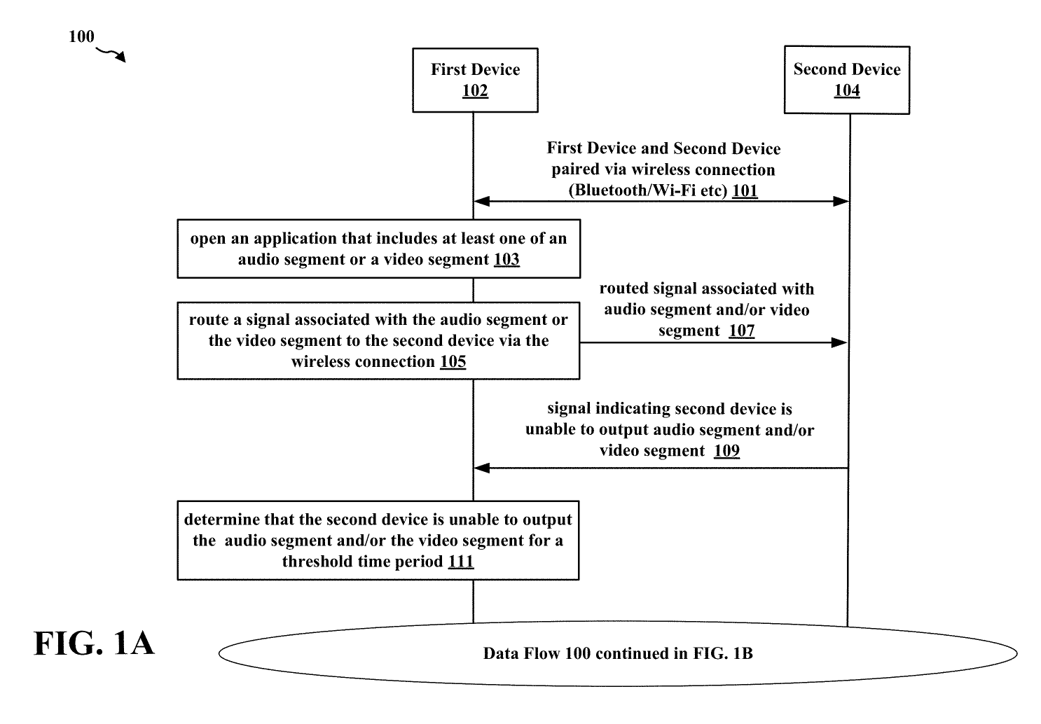

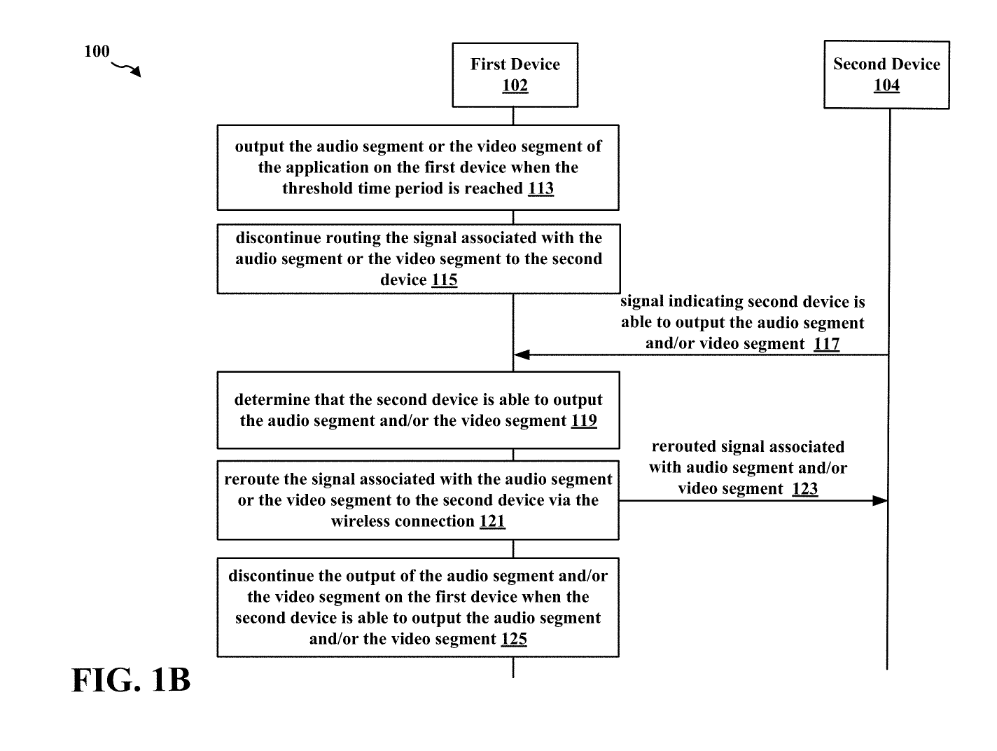

FIGS. 1A and 1B are a flow diagram 100 that may be used to output an audio segment and/or a video segment of an application at a first device 102 (e.g., a UE) when a second device 104 (e.g., a peripheral device) is unable to output the audio segment and/or video segment in accordance with certain aspects of the disclosure. In one aspect, the first device 102 may include a UE such as a smart phone, a smartwatch, a connected car, a drone, a fitness tracking device, a smart camera, a music player, smart eyewear, or any device that is able to communicate with another device using a non-cellular short range technology (e.g., Bluetooth™, IrDA™, SWAP HomeRF™, Wi-fi (e.g., IEEE 802.11), or BRAN HIPERLAN/2, etc.). In a further aspect, the second device 104 may include a peripheral device such as a smart phone, a smartwatch, a connected car, a drone, a fitness tracking device, a smart camera, a music player, smart headphones, smart eyewear, a smart television, a wireless speaker system, wireless headphones, a wireless earpiece, or any device that is able to connect to another device using the non-cellular short range technology.

In one aspect, the first device 102 may pair 101 with the second device 104 via a wireless connection. In certain configurations, first device 102 may pair 101 with the second device 104 using a pairing procedure.

The pairing procedure used by the first device 102 may include detecting the second device 104. For example, the first device 102 may monitor a communications link for identification information being transmitted and/or broadcast by the second device 104. In certain configurations, the first device 102 may receive a device identification from the second device 104, and the first device 102 may provide an identification instruction to the second device 104. The second device 104 may generate an identification output in response to the identification instruction received from the first device 102.

In one aspect, the first device 102 may receive a pairing instruction, e.g., based on a user input at the first device 102. For example, the pairing instruction may be received in response to input from a user that indicates to the first device 102 that the second device 104 is identifying itself (e.g., is generating an identification output). If the pairing instruction is a “do not pair” command, the first device 102 may provide an identification instruction to another device (e.g., not illustrated in FIGS. 1A and 1B) and/or can provide a cease identification instruction to the second device 104. A “do not pair” command may be a pairing instruction that instructs the first device 102 to not pair with a particular second device (e.g., the second device currently identifying itself).

If the pairing instruction is an “establish pairing” command, the first device 102 may provide a pairing request to the second device 104 to initiate a pairing session between the two devices. An “establish pairing” command may instruct the first device 102 to pair with a particular second device (e.g., the second device currently identifying itself). A pairing request may include a signal, command, and/or data packet transmission that indicates that the second device 104 is allowed to participate in a pairing session with the first device 102.

After the pairing procedure is completed, the first device 102 and the second device 104 may exchange data between the two devices. For example, audio signals and/or video signals may be provided from the first device 102 to the second device 104 (e.g., when the second device 104 is a speaker device and/or display device, respectively). In certain configurations, the first device 102 may communicate audio signals (e.g., associated with an audio segment of an application) and/or video signals (e.g., associated with a video segment of an application) to the second device 104 using a non-cellular short range technology (e.g., wireless connection) when the second device 104 is paired with the first device 102. In an aspect, the first device 102 and the second device 104 may communicate using Bluetooth™, IrDA™, SWAP HomeRF™, Wi-fi (e.g., IEEE 802.11), or BRAN HIPERLAN/2, just to name a few.

In another aspect, an application that includes at least one of an audio segment or a video segment may be opened at the first device 102. For example, the first device 102 may open 103 the application based on input received from a user. In one configuration, the application may include an audio file such as a MPEG-1 and/or MPEG-2 Audio Layer III (MP3) file, an MPEG-4 Part 14 or MPEG 4 AVC (MP4) file, a Waveform Audio File Format (WAV), an Ogg Audio file Format (Ogg), MPEG-4 Audio (M4A) file, and/or an advanced audio coding (AAC) file. In another configuration, the application may include a video file that includes both an audio segment and a video segment such as a WebM video file, a Matroska video file, a Flash Video (FLV) file, a F4V video file, a Video Object (VOB) file, an Ogg video file, a Dirac video file, a graphics interchange format (GIF) file, a video alternative to GIF file, a Multiple-Image Network Graphics file, an audio video interleaved (AVI) file, a QuickTime™ file, a Windows Media™ Video file, an M4V file, an Anime Music Video (AMV) file, etc.

In a further aspect, the first device 102 may route 105 a signal 107 associated with the at least one of the audio segment or the video segment to second device 104 via the wireless connection. For example, the signal 107 may be routed away from an internal device such as a speaker or video display located at the first device 102, so that the audio segment and/or video segment are not output at the first device 102. Instead, the audio segment and/or video segment may be output at the second device 104. In one aspect, an audio driver and/or video driver located at the first device 102 may be used to send the signal 107 associated with the audio segment and/or video segment to the second device 104. The audio driver and/or video driver may include a program that operates and/or controls certain functions of the second device 104 (e.g., such as outputting the audio segment and/or video segment of the application opened on the first device 102). For example, an audio driver and/or video driver of the first device 102 may be used so that the operating system oft the first device 102 knows how to translate the bits (e.g., 0's and 1's), of an audio file and/or video file, into audio signals and/or video signals that the audio driver and/or video driver sends to the second device 104 (e.g., headphones or speakers).

In certain scenarios, the first device 102 may determine 111 that the second device 104 is unable to output the signal associated with at least one of the audio segment or the video segment for a threshold time period. In one aspect, the first device 102 may determine 111 that the second device 104 is unable to output the signal of the audio segment and/or the video segment for a threshold time period based on a second signal 109 received from the second device 104. For example, the second device 104 may send the second signal 109 when the output component (e.g., speaker and/or display screen) at the second device 104 malfunctions for the threshold time period.

Additionally and/or alternatively, the first device 102 may determine 111 that the second device 104 is unable to output the signal associated with the audio segment and/or the video segment for a threshold time period by determining that the audio driver and/or video driver at the first device 102 (e.g., the audio driver and/or video driver associated with the second device 104) is not functioning properly for the threshold time period. In one aspect, the first device 102 may determine that the audio driver and/or video driver is not functioning properly when the first device 102 determines that audio and/or video driver is corrupted, not properly installed, and/or is broken. In one configuration, in order to determine whether a driver is corrupted, not properly installed, and/or broken, the first device 102 may maintain (e.g., store and/or have access to) a driver variable record in a list or look-up-table. Driver variable records may include a driver variable record header, a driver variable record name, and driver variable record data. The header may contain the variable structure definition and may inform the first device 102 of the size of the variable, a name of the component (e.g., transmission component 312) using the variable, and whether the variable is current or marked for deletion. The driver variable name may follow the header, and the driver variable data may follow the driver variable name. Additionally, since the header may provide the variable's name and data size, the first device 102 may be able to determine where the next variable should be in the linked-list and/or look-up-table if the header is corrupted.

As mentioned supra, the output signal the audio segment and/or the video segment at the second device 104 may be interrupted, for example, when the audio driver and/or video driver at the first device 102 (e.g., the audio driver and/or video driver associated with the second device 104) is corrupted, not properly installed, broken, and/or when the output component(s) (e.g., speaker and/or display screen) at the second device 104 malfunctions. Hence, the first device 102 may output 113 the audio segment and/or the video segment of the application on the first device 102 (e.g., using a distinct driver(s) associated with a speaker and/or display screen of the first device 102) in order to minimize or eliminate an interruption of the output of the audio segment and/or video segment of the application.

In addition, the first device 102 may discontinue 115 routing the signal associated with the at least one of the audio segment or the video segment to the second device 104 when the first device 102 determines that the audio driver and/or video driver at the first device 102 is corrupted, not properly installed, broken, and/or when the output component(s) (e.g., speaker and/or display screen) at the second device 104 malfunctions.

In certain scenarios, the first device 102 may determine 119 that the second device 104 is able to output the at least one of the audio segment or the video segment. For example, the speakers and/or display screen may no longer be malfunctioning. In one aspect, the first device 102 may determine 119 that the second device 104 is able to output the audio segment and/or the video segment based on a signal 117 received from the second device 104. For example, the second device 104 may send the signal 117 when the output component (e.g., speaker and/or display screen) at the second device 104 functions properly.

Additionally and/or alternatively, the first device 102 may determine 119 that the second device 104 is able to output the at least one of the audio segment or the video segment by determining that the audio driver and/or video driver at the first device 102 are functioning properly (e.g., no longer corrupted, broken, and/or not installed properly). For example, the first device 102 may use the driver variable records discussed supra to determine the audio driver and/or video driver associated with the second device 104 is functioning properly (e.g., is no longer corrupt). Further, the first device 102 may reroute 121 the signal 123 associated with the audio segment and/or the video segment to the second device 104 via the wireless connection. For example, the first device 102 may reroute 121 the signal 123 away from the internal device such as a speaker or video display located at the first device 102, and discontinue 125 the output of the audio segment and/or the video segment of the application on the first device 102 when the second device 104 is able to output the audio segment and/or the video segment.

Using the technique described supra with respect to FIGS. 1A and 1B, an interruption of the audio output and/or video output caused when the second device 104 is unable to output the audio segment and/or video segment may be minimized by outputting the audio segment and/or video segment of the application at the first device 102.

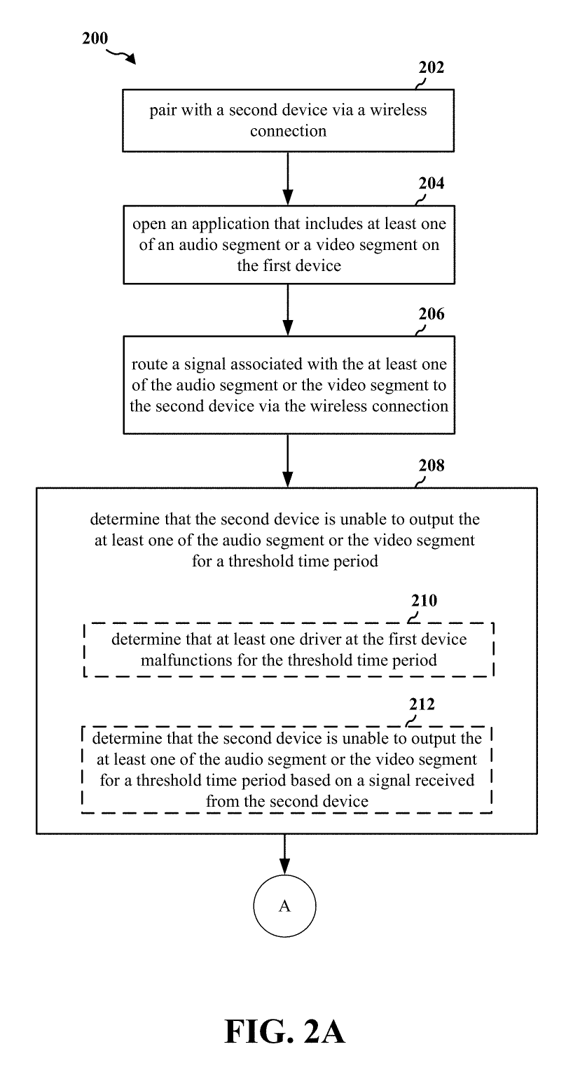

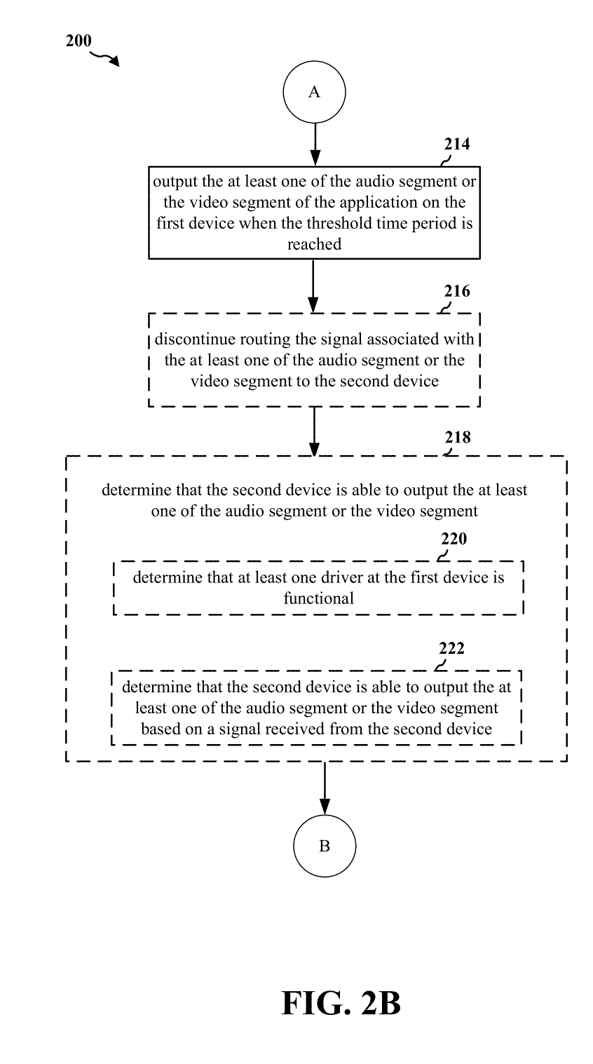

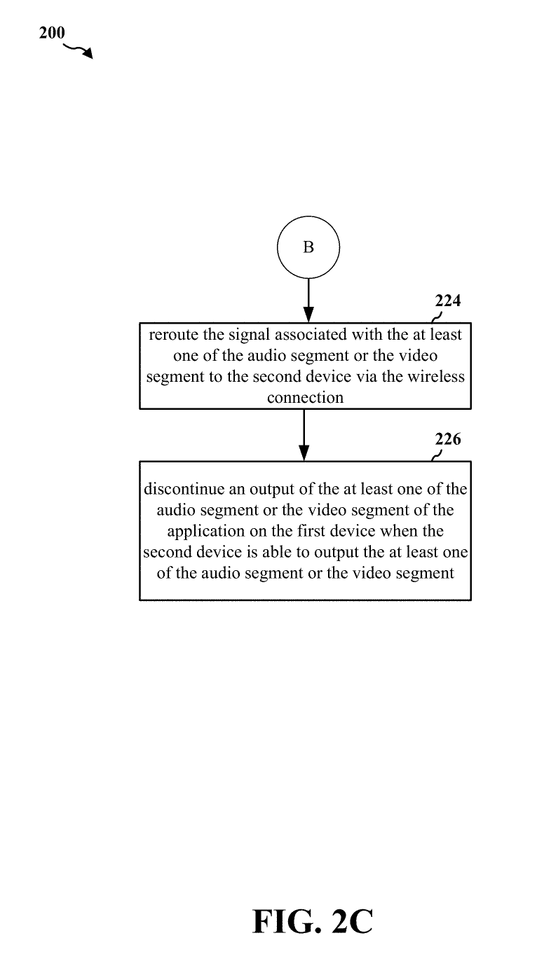

FIGS. 2A-2C are a flowchart 200 of a method of wireless communication. The method may be performed by a first device (e.g., the first device 102, the apparatus 302/302′) in communication with a second device (e.g., the second device 104). In FIGS. 2A-2C, operations with dashed lines indicate optional operations.

In FIG. 2A, at 202, the first device may pair with a second device via a wireless connection. For example, referring to FIG. 1A, the first device 102 may pair 101 with the second device 104 via a wireless connection. In certain configurations, first device 102 may pair 101 with the second device 104 using a pairing procedure. The pairing procedure used by the first device 102 may include detecting the second device 104. For example, the first device 102 may monitor a communications link for identification information being transmitted and/or broadcast by a second device 104. In certain configurations, the first device 102 may receive a device identification from the second device 104, and the first device 102 may provide an identification instruction to the second device 104. The second device 104 may generate an identification output in response to the identification instruction received from the first device 102. In one aspect, the first device 102 may receive a pairing instruction, e.g., based on a user input at the first device 102. For example, the pairing instruction may be received in response to input from a user that indicates to the first device 102 that the second device 104 is identifying itself (e.g., is generating an identification output). If the pairing instruction is a “do not pair” command, the first device 102 may provide an identification instruction to another device (e.g., not illustrated in FIGS. 1A and 1B) and/or can provide a cease identification instruction to the second device 104. A “do not pair” command may be a pairing instruction that instructs the first device 102 to not pair with a particular second device (e.g., the second device currently identifying itself). If the pairing instruction is an “establish pairing” command, the first device 102 may provide a pairing request to the second device 104 to initiate a pairing session between the two devices. An “establish pairing” command may instruct the first device 102 to pair with a particular second device (e.g., the second device currently identifying itself). A pairing request may include a signal, command, and/or data packet transmission that indicates that the second device 104 is allowed to participate in a pairing session with the first device 102. After the pairing procedure is completed, the first device 102 and the second device 104 may exchange data between the two devices. For example, audio signals and/or video signals may be provided from first device 102 to second device 104 (e.g., when second device 104 is a speaker device and/or display device, respectively). In certain configurations, the first device 102 may communicate audio signals and/or video signals to the second device 104 using a non-cellular short range technology (e.g., wireless connection) when the second device 104 is paired with the first device 102. In an aspect, the first device 102 and the second device 104 may communicate using Bluetooth™, IrDA™, SWAP HomeRF™, Wi-fi (e.g., IEEE 802.11), or BRAN HIPERLAN/2, just to name a few. In one aspect, the first device 102 may be a UE and the second device 104 may be a peripheral device. For example, the first device 102 may include a UE such as a smart phone, a smartwatch, a connected car, a drone, a fitness tracking device, a smart camera, a music player, smart eyewear, or any device that is able to communicate with another device using a non-cellular short range technology. In a further aspect, the second device 104 may include a peripheral device such as a smart phone, a smartwatch, a connected car, a drone, a fitness tracking device, a smart camera, a music player, smart headphones, smart eyewear, a smart television, a wireless speaker system, wireless headphones, a wireless earpiece, or any device that is able to connect to another device using a non-cellular short range technology.

In FIG. 2A, at 204, the first device may open an application that includes at least one of an audio segment or a video segment on the first device. For example, referring to FIG. 1A, an application that includes at least one of an audio segment or a video segment may be opened at the first device 102. For example, the first device 102 may open 103 the application based on input received from a user. In one configuration, the application may include an audio file such as an MP3 file, an MP4 file, an WAV file, an Ogg file, M4A file, and/or an AAC file. In another configuration, the application may include a video file that includes both an audio segment and a video segment such as a WebM video file, a Matroska video file, a FLV file, a F4V video file, a VOB video file, an Ogg video file, a Dirac video file, a GIF file, a video alternative to GIF file, a Multiple-Image Network Graphics file, an AVI file, a QuickTime file, a Windows Media Video file, an M4V file, an AMV video file, etc.

In FIG. 2A, at 206, the first device may route a signal associated with the at least one of the audio segment or the video segment to the second device via the wireless connection. For example, referring to FIG. 1A, the first device 102 may route 105 a signal 107 associated with the at least one of the audio segment or the video segment to second device 104 via the wireless connection. For example, the signal 107 may be routed away from an internal device such as a speaker or video display located at the first device 102, so that the audio segment and/or video segment are not output at the first device 102. Instead, the signal 107 may be sent to the second device 104 for outputting.

In FIG. 2A, at 208, the first device may determine that the second device is unable to output the at least one of the audio segment or the video segment for a threshold time period (e.g., 3 seconds). For example, referring to FIG. 1A, the first device 102 may determine 111 that the second device 104 is unable to output the at least one of the audio segment or the video segment for a threshold time period.

In FIG. 2A, at 210, the first device may determine that the second device is unable to output the at least one of the audio segment or the video segment for a threshold time period by determining that at least one driver at the first device malfunctions for the threshold time period. For example, referring to FIG. 1A, the first device 102 may determine 111 that the second device 104 is unable to output the audio segment and/or the video segment for a threshold time period by determining that the audio driver and/or video driver at the first device 102 is not functioning properly for the threshold time period. In one aspect, the first device 102 may determine that the audio driver and/or video driver is not functioning properly when the first device 102 determines that audio and/or video driver is corrupted, not properly installed, and/or is broken. In one configuration, in order to determine whether a driver is corrupted, not properly installed, and/or broken, the first device 102 may maintain (e.g., store and/or have access to) a driver variable record in a list or look-up-table. Driver variable records may include a driver variable record header, a driver variable record name, and driver variable record data. The header may contain the variable structure definition and may inform the first device 102 of the size of the variable, a name of the component (e.g., transmission component 312) using the variable, and whether the variable is current or marked for deletion. The driver variable name may follow the header, and the driver variable data may follow the driver variable name. Additionally, since the header may provide the variable's name and data size, the first device 102 may be able to determine where the next variable should be in the linked-list and/or look-up-table if the header is corrupted.

In FIG. 2A, at 212, the first device may determine that the second device is unable to output the at least one of the audio segment or the video segment for a threshold time period based on a signal received from the second device. For example, referring to FIG. 1A, the first device 102 may determine 111 that the second device 104 is unable to output the audio segment and/or the video segment for a threshold time period based on a signal 109 received from the second device 104. For example, the second device 104 may send the signal 109 when the output component (e.g., speaker and/or display screen) at the second device 104 malfunctions for the threshold time period.

In FIG. 2B, at 214, the first device may output the at least one of the audio segment or the video segment of the application on the first device when the threshold time period is reached. For example, referring to FIG. 1B, the first device 102 may output 113 the audio segment and/or the video segment of the application on the first device 102 (e.g., using a speaker and/or display screen at the first device 102) in order to minimize or eliminate an interruption of the output of the audio segment and/or video segment of the application.

In FIG. 2B, at 216, the first device may discontinue routing the signal associated with the at least one of the audio segment or the video segment to the second device. For example, referring to FIG. 1B, the first device 102 may discontinue 115 routing the signal associated with the at least one of the audio segment or the video segment to the second device 104 when the first device 102 determines that the audio driver and/or video driver (e.g., associated with the second device 104) at the first device 102 is corrupted, not properly installed, broken, and/or when the output component(s) (e.g., speaker and/or display screen) at the second device 104 malfunctions.

In FIG. 2B, at 218, the first device may determine that the second device is able to output the at least one of the audio segment or the video segment. For example, referring to FIG. 1B, the first device 102 may determine 119 that the second device 104 is able to output the at least one of the audio segment or the video segment.

In FIG. 2B, at 220, the first device may determine that the second device is able to output the at least one of the audio segment or the video segment by determining that at least one driver at the first device is functional. For example, referring to FIG. 1B, the first device 102 may determine 119 that the second device 104 is able to output the at least one of the audio segment or the video segment by determining that the audio driver and/or video driver at the first device 102 are functioning properly (e.g., no longer corrupted, broken, and/or not installed properly). For example, the first device 102 may use the driver variable records discussed supra to determine the audio driver and/or video driver associated with the second device 104 is functioning properly.

In FIG. 2B, at 222, the first device may determine that the second device is able to output the at least one of the audio segment or the video segment based on a signal received from the second device. For example, referring to FIG. 1B, the first device 102 may determine 119 that the second device 104 is able to output the audio segment and/or the video segment based on a signal 117 received from the second device 104. For example, the second device 104 may send the signal 109 when the output component (e.g., speaker and/or display screen) at the second device 104 functions properly. The signal 117 may indicate that the second device 104 is able to output the audio segment and/or the video segment.

In FIG. 2C, at 224, the first device may reroute the signal associated with the at least one of the audio segment or the video segment from the speaker and/or display screen within the first device 102 to the second device via the wireless connection. For example, referring to FIG. 1B, the first device 102 may reroute 121 the signal 123 associated with the audio segment and/or the video segment to the second device 104 via the wireless connection. For example, the first device 102 may reroute 121 the signal 123 away from the internal device such as a speaker or video display located within the first device 102.

In FIG. 2C, at 226, the first device may discontinue an output of the at least one of the audio segment or the video segment of the application on the first device when the second device is able to output the at least one of the audio segment or the video segment. For example, referring to FIG. 1B, the first device 102 may discontinue 125 the output of the audio segment and/or the video segment of the application on the first device 102 when the second device 104 is able to output the audio segment and/or the video segment.

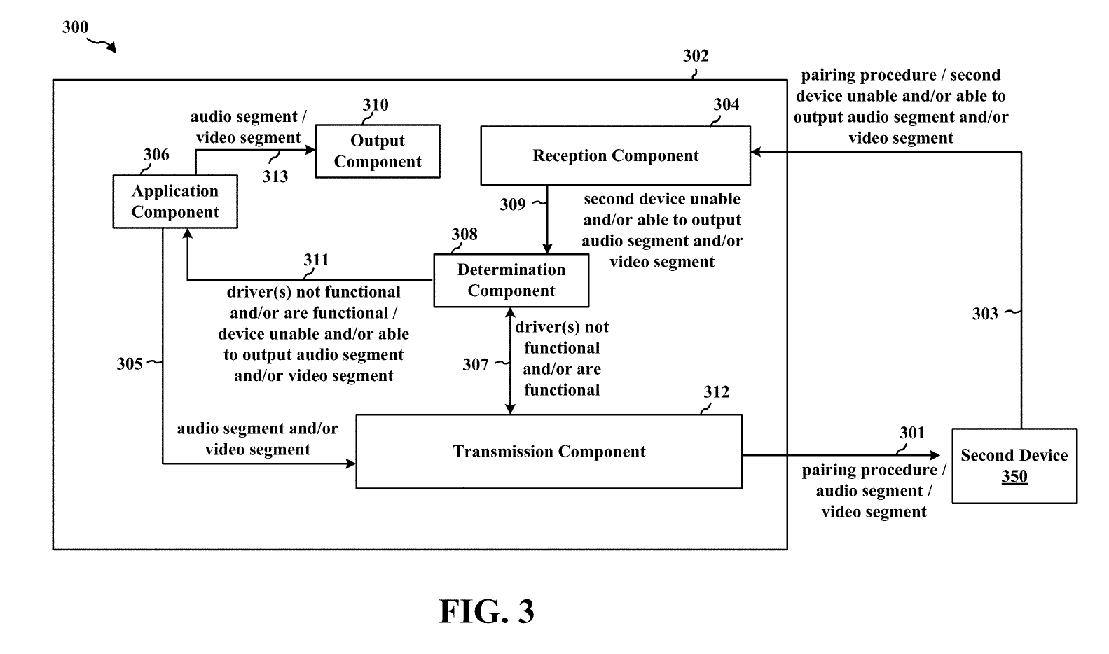

FIG. 3 is a conceptual data flow diagram 300 illustrating the data flow between different means/components in an exemplary apparatus 302. The apparatus may be a first device (e.g., UE 102, apparatus 302′) in communication with a second device 350 (e.g., peripheral device 104). The apparatus may include a reception component 304, an application component 306, a determination component 308, an output component 310, and a transmission component 312. Transmission component 312 and/or reception component 304 may perform a pairing procedure 301, 303 with second device 350 to establish a wireless connection with the second device 350. Application component 306 may open an application on the first device. In an aspect, the application may include at least one of an audio segment or a video segment. In addition, application component 306 may send a signal 305 associated with the audio segment and/or video segment of the application to transmission component 312. Transmission component 312 may route a signal 301 associated with the at least one of the audio segment or the video segment to the second device 350 via the wireless connection. Determination component 308 may determine that the second device is unable to output the at least one of the audio segment or the video segment for a threshold time period. In a first configuration, determination component 308 may receive a signal 307 from transmission component 312 that indicates that one or more drivers used to route the signal 301 associated with at least one of the audio segment or the video segment have malfunctioned for the threshold time period. In one aspect, the determination component 308 may poll the transmission component 312 for information associated with the functionality of the drivers. In another aspect, the transmission component 312 may send the signal 307 indicating the drivers are malfunctioning without being polled by the determination component 308. In a second configuration, the reception component 304 may receive a signal 303 from the second device 350 indicating that at least one of the audio segment or the video segment are not output at the second device 350. Reception component 304 may send a signal 309 indicating that the second device 350 is unable to output at least one of the audio segment or the video segment to determination component 308. In addition, determination component 308 may send a signal 311 to application component 306 indicating that either the driver(s) are not functioning properly for the threshold time period and/or that the second device 350 is unable to output at least one of the audio segment or video segment for the threshold time period. Application component 306 may discontinue sending the signal 305 associated with at least one of the audio segment or video segment to transmission component 312, and transmission component 312 may discontinue routing the signal 301 associated with at least one of the audio segment or the video segment to the second device 350. Further, application component 306 may send a signal 313 associated with at least one of the audio segment and/or video segment to output component 310. Output component 310 may output the at least one of the audio segment or the video segment of the application on the first device when the threshold time period is reached (e.g., when signal 313 is received). Determination component 308 may determine that the second device 350 is able to output the at least one of the audio segment or the video segment. In a third configuration, determination component 308 may receive a signal 307 from transmission component 312 that indicates that the one or more drivers used to route the signal 301 associated with at least one of the audio segment or the video segment are functioning properly. In one aspect, the determination component 308 may poll the transmission component 312 for information associated with the functionality of the drivers. In another aspect, the transmission component 312 may send the signal 307 indicating the drivers are functioning properly without being polled by the determination component 308. In a fourth configuration, the reception component 304 may receive a signal 303 from the second device 350 indicating that at least one of the audio segment or the video segment are output at the second device 350. Reception component 304 may send a signal 309 indicating that the second device 350 is able to output at least one of the audio segment or the video segment to determination component 308. In addition, determination component 308 may send a signal 311 to application component 306 indicating that either the driver(s) are functioning properly and/or that the second device 350 is able to output at least one of the audio segment or video segment. Application component 306 may reroute the signal 305 associated with the at least one of the audio segment or the video segment to the second device to transmission component 312, and discontinue sending the signal 313 to output component 310. Transmission component 312 may reroute the signal 301 associated with the at least one of the audio segment or the video segment to the second device to the second device 350.

The apparatus may include additional components that perform each of the blocks of the algorithm in the aforementioned flowcharts of FIGS. 2A-2C. As such, each block in the aforementioned flowcharts of FIGS. 2A-2C may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

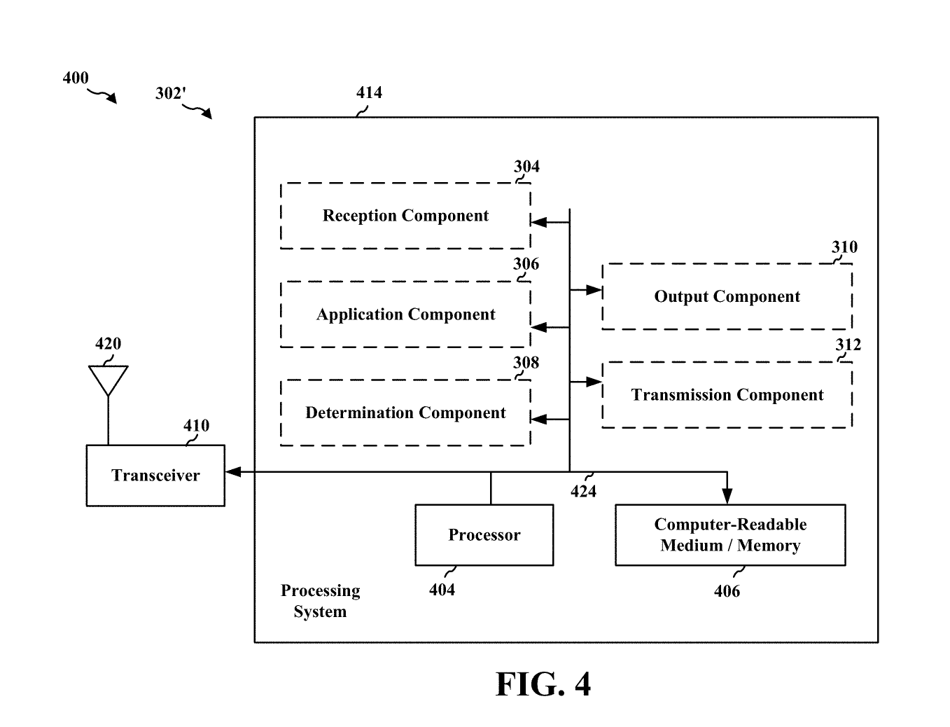

FIG. 4 is a diagram 400 illustrating an example of a hardware implementation for an apparatus 302′ employing a processing system 414. The processing system 414 may be implemented with a bus architecture, represented generally by the bus 424. The bus 424 may include any number of interconnecting buses and bridges depending on the specific application of the processing system 414 and the overall design constraints. The bus 424 links together various circuits including one or more processors and/or hardware components, represented by the processor 404, the components 304, 306, 308, 310, 312 and the computer-readable medium/memory 406. The bus 424 may also link various other circuits such as timing sources, peripherals, voltage regulators, and power management circuits, which are well known in the art, and therefore, will not be described any further.

The processing system 414 may be coupled to a transceiver 410. The transceiver 410 is coupled to one or more antennas 420. The transceiver 410 provides a means for communicating with various other apparatus over a transmission medium. The transceiver 410 receives a signal from the one or more antennas 420, extracts information from the received signal, and provides the extracted information to the processing system 414, specifically the reception component 304. In addition, the transceiver 410 receives information from the processing system 414, specifically the transmission component 312, and based on the received information, generates a signal to be applied to the one or more antennas 420. The processing system 414 includes a processor 404 coupled to a computer-readable medium/memory 406. The processor 404 is responsible for general processing, including the execution of software stored on the computer-readable medium/memory 406. The software, when executed by the processor 404, causes the processing system 414 to perform the various functions described supra for any particular apparatus. The computer-readable medium/memory 406 may also be used for storing data that is manipulated by the processor 404 when executing software. The processing system 414 further includes at least one of the components 304, 306, 308, 310, 312. The components may be software components running in the processor 404, resident/stored in the computer readable medium/memory 406, one or more hardware components coupled to the processor 404, or some combination thereof.

In one configuration, the apparatus 302/302′ for wireless communication may include means for pairing with a second device via a wireless connection. In one aspect, the first device may be a UE and the second device may be a peripheral device. In another configuration, the apparatus 302/302′ for wireless communication may include means for opening an application on the first device. In an aspect, the application may include at least one of an audio segment or a video segment. In a further configuration, the apparatus 302/302′ for wireless communication may include means for routing a signal associated with the at least one of the audio segment or the video segment to the second device via the wireless connection. In one configuration, the apparatus 302/302′ for wireless communication may include means for determining that the second device is unable to output the at least one of the audio segment or the video segment for a threshold time period. In one aspect, the means for determining that the second device is unable to output the at least one of the audio segment or the video segment for a threshold time period may be configured to determine that at least one driver at the first device malfunctions for the threshold time period. In another aspect, the means for determining that the second device is unable to output the at least one of the audio segment or the video segment for a threshold time period may be configured to determine that the second device is unable to output the at least one of the audio segment or the video segment for a threshold time period based on a signal received from the second device. In another configuration, the apparatus 302/302′ for wireless communication may include means for outputting the at least one of the audio segment or the video segment of the application on the first device when the threshold time period is reached. In a further configuration, the apparatus 302/302′ for wireless communication may include means for discontinuing routing the signal associated with the at least one of the audio segment or the video segment to the second device. In one aspect, the apparatus 302/302′ for wireless communication may include means for determining that the second device is able to output the at least one of the audio segment or the video segment. In one aspect, the means for determining that the second device is able to output the at least one of the audio segment or the video segment may be configured to determine that at least one driver at the first device is functional. In another aspect, the means for determining that the second device is able to output the at least one of the audio segment or the video segment may be configured to determine that the second device is able to output the at least one of the audio segment or the video segment based on a signal received from the second device. In another aspect, the apparatus 302/302′ for wireless communication may include means for rerouting the signal associated with the at least one of the audio segment or the video segment to the second device via the wireless connection. In a further configuration, the apparatus 302/302′ for wireless communication may include means for discontinuing an output of the at least one of the audio segment or the video segment of the application on the first device when the second device is able to output the at least one of the audio segment or the video segment. The aforementioned means may be one or more of the aforementioned components of the apparatus 302 and/or the processing system 414 of the apparatus 302′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method for wireless communication by a first device, comprising:
pairing with a second device via a wireless connection;
opening an application on the first device, the application including at least one of an audio segment or a video segment;
routing a signal associated with the at least one of the audio segment or the video segment to the second device via the wireless connection;
determining that the second device is unable to output the at least one of the audio segment or the video segment for a threshold time period; and
outputting the at least one of the audio segment or the video segment of the application on the first device when the threshold time period is reached.

2. The method of claim 1, further comprising:
determining that the second device is able to output the at least one of the audio segment or the video segment;
rerouting the signal associated with the at least one of the audio segment or the video segment to the second device via the wireless connection; and
discontinuing an output of the at least one of the audio segment or the video segment of the application on the first device when the second device is able to output the at least one of the audio segment or the video segment.

3. The method of claim 1, further comprising:
discontinuing routing the signal associated with the at least one of the audio segment or the video segment to the second device.

4. The method of claim 1, wherein the first device is a user equipment (UE) and the second device is a peripheral device.

5. The method of claim 1, wherein the determining that the second device is unable to output the at least one of the audio segment or the video segment for a threshold time period comprises:
determining that at least one driver at the first device malfunctions for the threshold time period.

6. The method of claim 1, wherein the determining that the second device is unable to output the at least one of the audio segment or the video segment for a threshold time period comprises:
receiving a signal indicating that the second device is unable to output the at least one of the audio segment or the video segment.

7. The method of claim 2, wherein the determining that the second device is able to output the at least one of the audio segment or the video segment comprises:
determining that at least one driver at the first device is functional.

8. The method of claim 2, wherein the determining that the second device is able to output the at least one of the audio segment or the video segment comprises:
receiving a signal indicating that the second device is able to output the at least one of the audio segment or the video segment.

9. An apparatus for wireless communication by a first device, comprising:
means for pairing with a second device via a wireless connection;
means for opening an application on the first device, the application including at least one of an audio segment or a video segment;
means for routing a signal associated with the at least one of the audio segment or the video segment to the second device via the wireless connection;
means for determining that the second device is unable to output the at least one of the audio segment or the video segment for a threshold time period; and
means for outputting the at least one of the audio segment or the video segment of the application on the first device when the threshold time period is reached.

10. The apparatus of claim 9, further comprising:
means for determining that the second device is able to output the at least one of the audio segment or the video segment;
means for rerouting the signal associated with the at least one of the audio segment or the video segment to the second device via the wireless connection; and
means for discontinuing an output of the at least one of the audio segment or the video segment of the application on the first device when the second device is able to output the at least one of the audio segment or the video segment.

11. The apparatus of claim 9, further comprising:
means for discontinuing routing the signal associated with the at least one of the audio segment or the video segment to the second device.

12. The apparatus of claim 9, wherein the first device is a user equipment (UE) and the second device is a peripheral device.

13. The apparatus of claim 9, wherein the means for determining that the second device is unable to output the at least one of the audio segment or the video segment for a threshold time period is configured to:
determine that at least one driver at the first device malfunctions for the threshold time period.

14. The apparatus of claim 9, wherein the means for determining that the second device is unable to output the at least one of the audio segment or the video segment for a threshold time period is configured to:
receive a signal indicating that the second device is unable to output the at least one of the audio segment or the video segment.

15. The apparatus of claim 10, wherein the means for determining that the second device is able to output the at least one of the audio segment or the video segment is configured to:
determine that at least one driver at the first device is functional.

16. The apparatus of claim 10, wherein the means for determining that the second device is able to output the at least one of the audio segment or the video segment is configured to:
receive a signal indicating that the second device is able to output the at least one of the audio segment or the video segment.

17. An apparatus for wireless communication by a first device, comprising:
a memory; and
at least one processor coupled to the memory and configured to:
pair with a second device via a wireless connection;
open an application on the first device, the application including at least one of an audio segment or a video segment;
route a signal associated with the at least one of the audio segment or the video segment to the second device via the wireless connection;
determine that the second device is unable to output the at least one of the audio segment or the video segment for a threshold time period; and
output the at least one of the audio segment or the video segment of the application on the first device when the threshold time period is reached.

18. The apparatus of claim 17, wherein the at least one processor is further configured to:
determine that the second device is able to output the at least one of the audio segment or the video segment;
reroute the signal associated with the at least one of the audio segment or the video segment to the second device via the wireless connection; and
discontinue an output of the at least one of the audio segment or the video segment of the application on the first device when the second device is able to output the at least one of the audio segment or the video segment.

19. The apparatus of claim 17, wherein the at least one processor is further configured to:
discontinue routing the signal associated with the at least one of the audio segment or the video segment to the second device.

20. The apparatus of claim 17, wherein the first device is a user equipment (UE) and the second device is a peripheral device.

21. The apparatus of claim 17, wherein the at least one processor is configured to determine that the second device is unable to output the at least one of the audio segment or the video segment for a threshold time period by:
determining that at least one driver at the first device malfunctions for the threshold time period.

22. The apparatus of claim 17, wherein the at least one processor is configured to determine that the second device is unable to output the at least one of the audio segment or the video segment for a threshold time period is configured by:
receiving a signal indicating that the second device is unable to output the at least one of the audio segment or the video segment.

23. The apparatus of claim 18, wherein the at least one processor is configured to determine that the second device is able to output the at least one of the audio segment or the video segment by:
determining that at least one driver at the first device is functional.

24. The apparatus of claim 18, wherein the at least one processor is configured to determine that the second device is able to output the at least one of the audio segment or the video segment by:
receiving a signal indicating that the second device is able to output the at least one of the audio segment or the video segment.

25. A non-transitory computer-readable medium storing computer executable code for a first device, comprising code to:
pair with a second device via a wireless connection;
open an application on the first device, the application including at least one of an audio segment or a video segment;
route a signal associated with the at least one of the audio segment or the video segment to the second device via the wireless connection;
determine that the second device is unable to output the at least one of the audio segment or the video segment for a threshold time period; and
output the at least one of the audio segment or the video segment of the application on the first device when the threshold time period is reached.

26. The non-transitory computer-readable medium of claim 25, wherein the code is further configured to:
determine that the second device is able to output the at least one of the audio segment or the video segment;
reroute the signal associated with the at least one of the audio segment or the video segment to the second device via the wireless connection; and
discontinue an output of the at least one of the audio segment or the video segment of the application on the first device when the second device is able to output the at least one of the audio segment or the video segment.

27. The non-transitory computer-readable medium of claim 25, wherein the code is further configured to:
discontinue routing the signal associated with the at least one of the audio segment or the video segment to the second device.

28. The non-transitory computer-readable medium of claim 25, wherein the first device is a user equipment (UE) and the second device is a peripheral device.

29. The non-transitory computer-readable medium of claim 25, wherein the code is configured to determine that the second device is unable to output the at least one of the audio segment or the video segment for a threshold time period by:
determining that at least one driver at the first device malfunctions for the threshold time period.

30. The non-transitory computer-readable medium of claim 25, wherein the code is configured to determine that the second device is unable to output the at least one of the audio segment or the video segment for a threshold time period by:
receiving a signal indicating that the second device is unable to output the at least one of the audio segment or the video segment.
